(19) United States
(12) Patent Application Publication
(10) Pub. No.: US 2007/0186978 A1
(43) Pub. Date: Aug. 16, 2007

(54) Portable tire pump

(76) Inventor: Yu-Cheng Lin, Taipei City (TW)

Correspondence Address: HDSL, 4331 STEVENS BATTLE LANE, FAIRFAX, VA, 22033, US

(21) Appl. No.: 11/354,017

(22) Filed: Feb. 15, 2006

(51) Int. Cl. F16K 15/20

(52) U.S. Cl. 137/227

(57) ABSTRACT

A portable tire pump includes a small refillable gas bottle and a control device connected to the gas bottle. The control device includes an inlet channel with one end connected to the connecting end, an outlet channel with one end connected to an air injecting tub, and an airflow controller connected with the other ends of the inlet and the outlet channels to conduct and control air flowing from the gas bottle to pump into a tire.

### BACKGROUND OF THE INVENTION

1. Field of Invention

The present invention relates in general to a tire pump, and more particular, to a portable tire pump.

2. Related Art

For driving safety, it is important to keep the tire pressure of a vehicle in normal. Lower pressure in a tire can cause fuel-consuming, influence to control the vehicle or quickly rubbing of the tire, even blowout. It is inconvenient for drivers to find places or get help for pumping when needed.

### SUMMARY OF THE INVENTION

The present invention is to provide a portable tire pump for drivers to keep the tire pressure normally if needed.

The portable tire pump of the present invention is reusable to be environmental friendly.

Accordingly, the portable tire pump of the present invention includes a small gas bottle refillable of high-pressure gas and a control device. The gas bottle includes a connector for the gas flowing out and a venting valve formed on the top thereof. The control device has a connecting end for the connector of the gas bottle connected thereto and a distal end opposite to the connecting end formed with an opening. Inside the control device, it is provided an inlet channel with one end connected to the connecting end, an outlet channel with one end connected to an air injecting tub, an inner tank, with a first diameter, connected with the other ends of the inlet and the outlet channels, a middle tank, with a second diameter larger than the first diameter, connected to the inner tank, an outer tank, with a third diameter larger than the second diameter, connected between the middle tank and the opening, a block including a first, a second and a third sections and a through channel formed inside, the first section being located in the inner tank to block the connection of the inlet channel and the inner tank, the second section, with a diameter larger than that of the first section and substantially equal to but smaller than the second diameter, being connected between the first and the third sections, the third section, with a diameter larger than that of the second section and substantially equal to but smaller than the third diameter, being located in the outer tank, a first spring installed in the middle tank to press on the third section, a plug, with a cavity formed on an inner surface thereof, mounted in the opening, and a second spring located in the cavity to press on the third block section.

### BRIEF DESCRIPTION OF THE DRAWINGS

The present invention will become more fully understood from the detailed description given hereinbelow illustration only, and thus are not limitative of the present invention, and wherein:

FIG. 1 shows a perspective view of a portable tire pump according to the present invention;

FIG. 2 shows a cross sectional view for a control device of the portable tire pump;

FIG. 3 shows an air injecting tube of the control device connected to a pumping tube;

FIG. 4 shows another preferred embodiment in FIG. 3;

FIG. 5 shows the portable tire pump of the present invention in use;

FIG. 6 shows airflow in the control device when pumping;

FIG. 7 shows the control device when the pumping is finished; and

FIG. 8 shows another embodiment of the portable tire pump in use.

### DETAILED DESCRIPTION OF THE INVENTION

A portable tire pump of the present invention helps the drivers capable of inflating the tires to normal pressure instantly so that various dangers and inconvenience can be prevented.

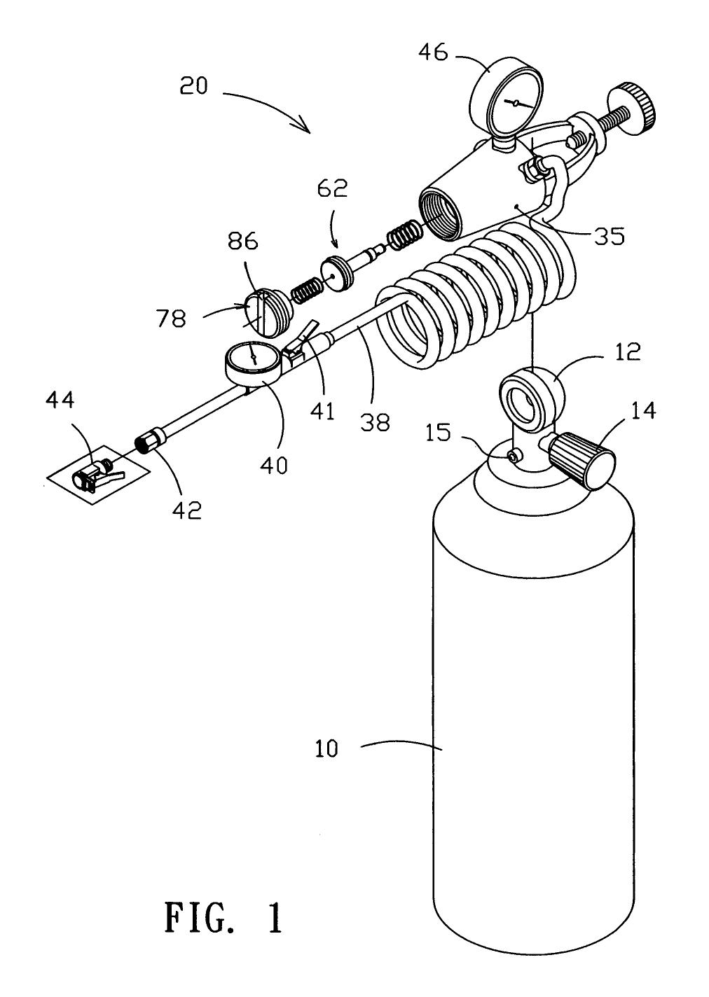

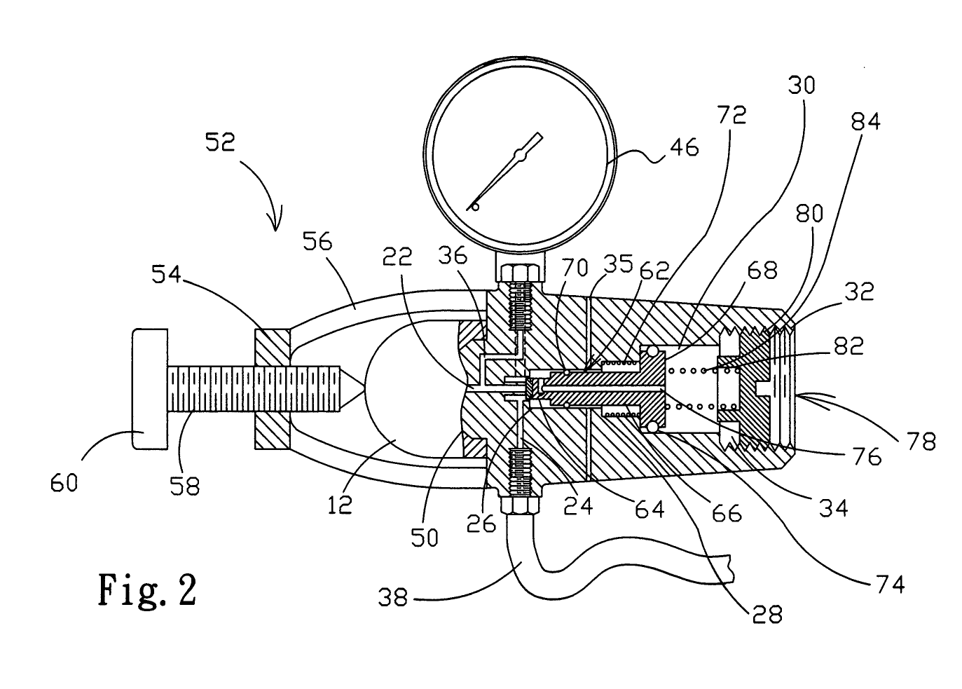

Referring to FIGS. 1 and 2, a portable tire pump includes a small gas bottle 10 which is refillable of high-pressure gas and a control device 20. A connector 12 to let the gas flow out, a knob 14 to switch the outflow and a venting valve 15 for safety are formed on the top of the gas bottle 10.

Inside the control device 2, an inlet channel 22, an outlet channel 24, an inner tank 26 connected with the inlet and the outlet channels 22 and 24, a middle tank 28 connected to the inner tank 26, an outer tank 30 connected to the middle tank 28 and an opening 34 connected to the outer tank 30 are provided. The opening 34 with an interior thread 32 is formed at a distal end opposite to a connecting end 50 of the control device 2. The inner, the middle, the outer tanks 26, 28, 30 and the opening 34 are in a telescopic structure with successively expanding diameters. There are through holes 35 formed on two sides of the control device 2 to connect to the inner tank 26 and a residual gas monitoring channel 36 with one end connected to the inlet channel 22 and the other end connected to a pressure gauge 46.

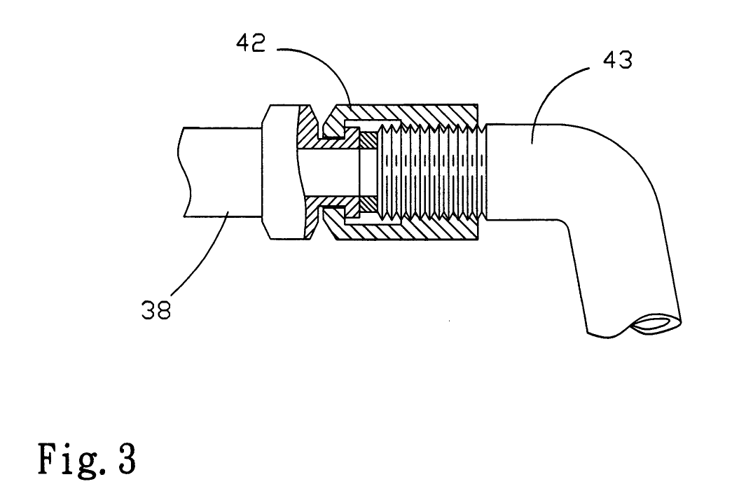

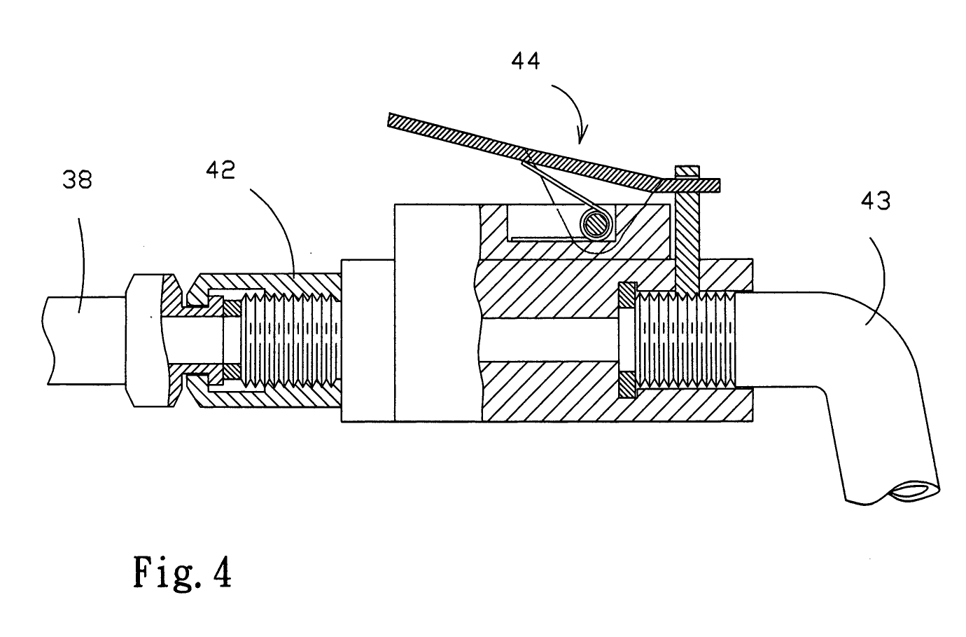

The outlet channel 24 is connected to an air injecting tube 38. Another pressure gauge 40 and a switch 41 are connected with the air injecting tube 38. The distal end of the air injecting tube 38 is formed an engaging element 42 to securely connect with a pumping tube 43, or an adapter 44 can be additionally used for connection, as shown in FIGS. 3 and 4.

The connecting end 50 is for the connector 12 to connect to the inlet channel 22. The control device 20 further includes a fixing element 52 to secure the connection of the connecting end 50 and the connector 12.

In the preferred embodiment, the fixing element 52 includes a base 54 and two arms 56 extending from the base 54 to be connected between the main body of the control device 12 and the base 54. A screw column 58 with a rotator 60 at bottom can pass through the base 54 to have the tiptop push against on the outer surface of the connector 12 so that the connector 12 can be closely fastened on the connecting end 50.

A block 62 including telescopic first, second and third sections 64, 66 and 68 and a through channel 76 formed inside the block 62 is installed in the tanks 26, 28, 30. The through channel 76 has one end open to the side of the first block section 64 and the other end open to the bottom of the third block section 68. The first block section 64 with a diameter smaller than that of the inner tank 26 is wholly located in the inner tank 26. The second block section 66 with a diameter larger than the first section 64 and substantially equal to but smaller than that of the inner tank 26 is connected between the first and the second block sections 62 and 64. The third block section 68 with a diameter larger than the second section 66 and substantially equal to but smaller than that of the outer tank 30 is wholly located in the outer tank 30. Moreover, there are O-rings 70 and 74 mounted between the second block section 66 and the inner tank 26 and between the third block section 68 and the outer tank 30 for sealing. A spring 72 is installed in the middle tank 28 to press on the third block section 68.

A plug 78 for positioning the block 62 and the spring 72 inside the tanks 26, 28, 30 is mounted in the opening 34. The plug 78 has an outer thread 80 engaged with the inner thread 32 of the opening 34 to screw therein. A cavity 82 is formed on an inner surface of the plug 78 to have another spring 84 located therein to press on the third block section 68 from the bottom side. In order to facilitate screwing of the plug 78, a line or cross slot is formed on an outer surface of the plug 78 for conveniently using a coin or by a screw driver to screw the plug 78 in the opening 34.

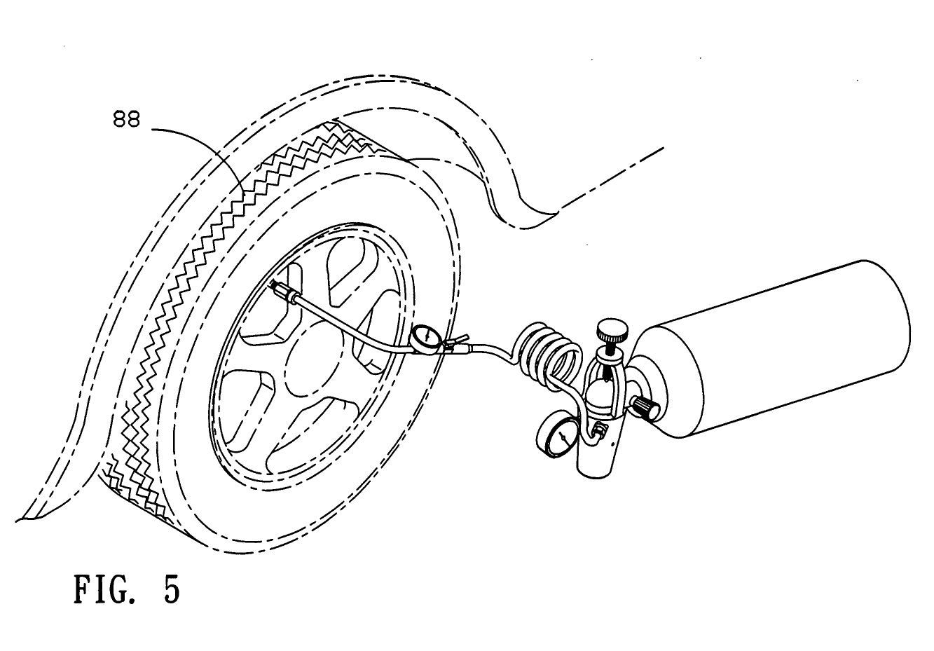

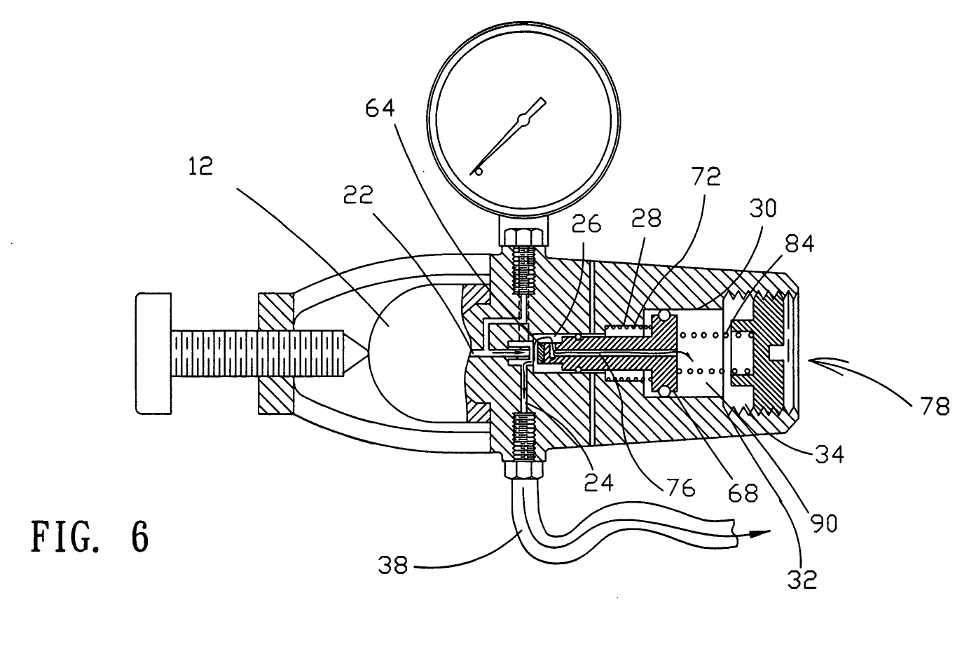

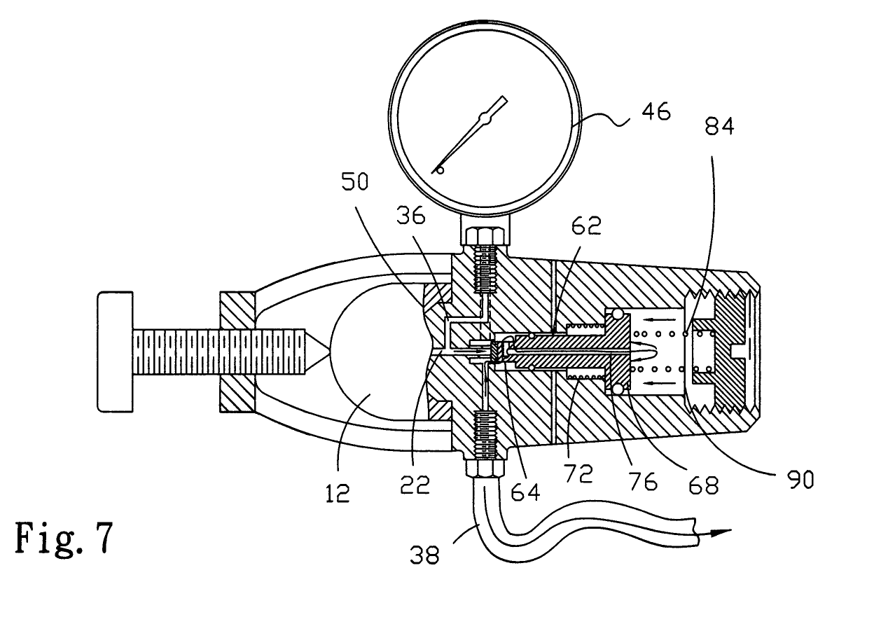

Referring to FIG. 5, when inflating the tire 88, first is to adjust a position of the plug 78 screwed in the 34 so that a maximum air volume being pumping into the tire 88 per cycle is determined on the size of a space 90 formed between the third block section 68 and the plug 78, as shown in FIG. 6, by adjusting the spring force of the spring 84 pressed on the third block section 68. When pumping, the air flows from the gas bottle 10 to the inner tank 26 and the outlet channel 24 through the inlet channel 22. The air in the inner tank 26 then flows to the space 90 via the through channel 76. If more air flowing in the space 90 is over the predetermined volume of the space 90, the air will press on the third block section 68 against the resilient force of the springs 72, 84 to push the block 62 and the first block section 64 will then move to close the inlet channel 22 so as to stop inflow of air, as shown in FIG. 7. As such, the air in the space 90 can be pumped via the through channel 76, the outlet channel 24 and the air injecting tube 38 into the tire 88. After the air flows out of the space 90, the springs 72, 84 will make the block 62 return to the position in FIG. 6 again. Therefore, by repeating, as the tire 88 is inflated at a predetermined pressure, the air cannot be pumped into the tire 88 any more, the block 62 will remain to close the inlet channel 22 as in FIG. 7. Accordingly, various dangers by directly pumping air from high-pressure gas bottle into tires can be prevented.

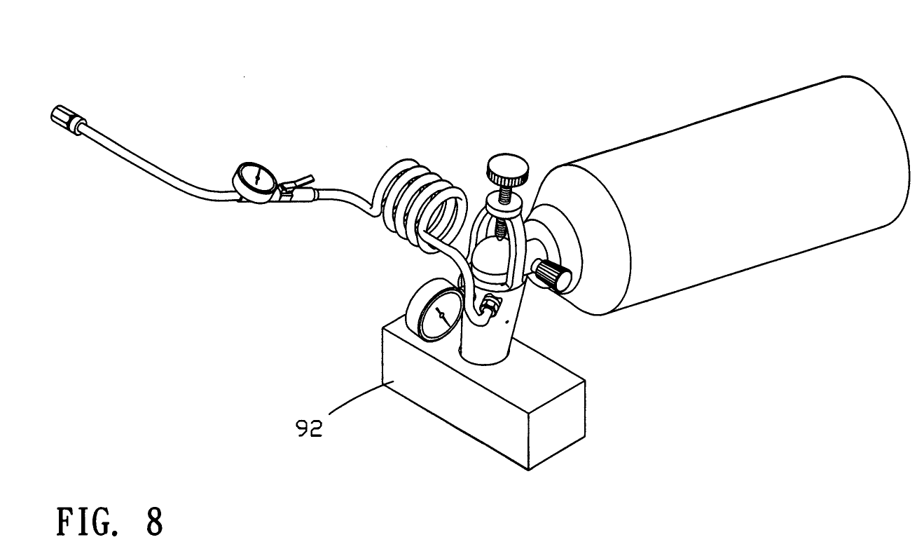

Finally, as shown in FIG. 8, a holder 92 can be provided to hold the portable pumping device of the present invention. Moreover, the holder 92 can includes a LED or other lighting device for illumination and alarm.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable tire pump, comprising:
a small gas bottle refillable of high-pressure gas, including a connector for the gas flowing out and a venting valve formed on the top thereof; and
a control device having a connecting end for the connector of the gas bottle connected thereto and a distal end opposite to the connecting end formed with an opening, inside the control device including an inlet channel with one end connected to the connecting end, an outlet channel with one end connected to an air injecting tub, an inner tank, with a first diameter, connected with the other ends of the inlet and the outlet channels, a middle tank, with a second diameter larger than the first diameter, connected to the inner tank, an outer tank, with a third diameter larger than the second diameter, connected between the middle tank and the opening, a block including a first, a second and a third sections and a through channel formed inside, the first section being located in the inner tank to block the connection of the inlet channel and the inner tank, the second section, with a diameter larger than that of the first section and substantially equal to but smaller than the second diameter, being connected between the first and the third sections, the third section, with a diameter larger than that of the second section and substantially equal to but smaller than the third diameter, being located in the outer tank, a first spring installed in the middle tank to press on the third section, a plug, with a cavity formed on an inner surface thereof, mounted in the opening, and a second spring located in the cavity to press on the third block section.

2. The portable tire pump of claim 1, wherein inside the control device further comprises a residual gas monitoring channel with one end connected to the inlet channel and the other end connected with a pressure gauge.

3. The portable tire pump of claim 1, wherein the control device further comprises a fixing element to secure the connection of the connector to the connecting end.

4. The portable tire pump of claim 3, wherein the fixing element includes a base, a plurality of arms extending from the base to connect between the control device and the base, and a screw column with a rotator at bottom passing through the base to push against on the connector.

5. The portable tire pump of claim 1, wherein the control device further comprises two O-rings mounted between the second section and the inner tank and between the third section and the outer tank for sealing, respectively.

6. The portable tire pump of claim 1, further comprising a pressure gauge connected to the air injecting tube.

7. The portable tire pump of claim 1, wherein a distal end of the air injecting tube is formed an engaging element or additionally mounting an adapter on the engaging element to securely connect with a pumping tube.

8. The portable tire pump of claim 1, further comprising a holder 92 to hold the control device.

9. The portable tire pump of claim 1, wherein the plug has a line or cross slot formed on an outer surface thereof.

10. A portable tire pump, comprising:
a small gas bottle refillable of high-pressure gas, including a connector for the gas flowing out and a venting valve formed on the top thereof; and
a control device with a connecting end for the connector of the gas bottle connected thereto, including an inlet channel with one end connected to the connecting end, an outlet channel with one end connected to an air injecting tub, and an airflow controller connected with the other ends of the inlet and the outlet channels to conduct and control air flowing from the gas bottle to pump into a tire.
